(19) United States
(12) Patent Application Publication
(10) Pub. No.: US 2022/0263153 A1
(43) Pub. Date: Aug. 18, 2022

(54) HEAT SINK FOR ACCUMULATOR CELLS, AS WELL AS AN ACCUMULATOR

(71) Applicant: Mahle International GmbH, Stuttgart (DE)

(72) Inventors: Sarah Gorzellik, Stuttgart (DE); Erik Person, Stuttgart (DE)

(21) Appl. No.: 17/671,305

(22) Filed: Feb. 14, 2022

(30) Foreign Application Priority Data
Feb. 12, 2021 (DE) 102021201340.6

(51) Int. Cl. H01M 10/6554; H01M 10/613; H01M 10/647; H01M 10/6556; H01M 10/625; H01M 50/211

(52) U.S. Cl. CPC H01M 10/6554; H01M 10/613; H01M 10/647; H01M 2220/20; H01M 10/625; H01M 50/211; H01M 10/6556

(57) ABSTRACT

A heat sink for accumulator cells of an accumulator, the heat sink may include a closed outer shell and two connections. The closed outer shell may delimit an inner volume of the heat sink. The outer shell may include a first wall and a second wall opposite the first wall in a direction of spacing. The first and second walls may be movable relative to one another in the direction of spacing. The two connections may be arranged at a periphery of the outer shell. The connections may be fluidically connected to the inner volume such that a flow path of a cooling fluid extends through the inner volume via the connections.

### CROSS-REFERENCE TO RELATED APPLICATION

This application claims priority to German Patent Application No. DE 102021201340.6, filed on Feb. 12, 2021, the contents of which is hereby incorporated by reference in its entirety.

### TECHNICAL FIELD

The present invention relates to a heat sink for accumulator cells, in particular pouch cells, of an accumulator. The invention further relates to an accumulator with at least two accumulator cells and at least one such heat sink.

### BACKGROUND

An accumulator is used for the repeatable storage and release of electrical energy. For this purpose, an accumulator generally has several rechargeable accumulator cells. The respective accumulator cell has a shell or a housing, in which at least one electrochemically active material is accommodated, and on which two electrodes are provided for tapping the electrical energy stored in the accumulator cell and for recharging the accumulator cell. In an accumulator, several such accumulator cells can be arranged adjacent to each other and combined to form a cell stack.

During operation of the accumulator, i.e., in particular when charging and/or discharging the accumulator cells, heat is generated, which can reduce the efficiency of the accumulator and lead to damage and failure of the accumulator cells. In particular, in connection with accumulator cells designed as pouch cells, swelling of the deformable housing of the cells, which is usually made of foil, is problematic. To limit thermal expansions of the accumulator cells, they are usually arranged in the associated cell stack between generally plate-shaped brackets, which are prestressed against each other.

It is, furthermore, desirable to be able to heat the accumulator, when required, e.g., to enable operation of the accumulator, even at very low outside temperatures.

In particular, said thermal effects and requirements increasingly require temperature control, i.e., cooling and/or heating of the accumulator.

With increasing operating accumulator voltages, which occur with increased frequency, in particular, in accumulators used in motor vehicles, said effects and requirements become greater and thus increasingly require active temperature control of the accumulator.

In principle, the temperature of the accumulator can be controlled by controlling the temperature of an accumulator housing, in which the accumulator cells are arranged. However, this limits the available temperature control of the accumulator cells.

It is also conceivable to guide a coolant, at least partially, through the accumulator housing. In such a variant, there is usually fluidic separation between the accumulator cells and the cooling fluid, such that the coolant controls the temperature of the accumulator cells on each front side. This, in turn, results in insufficient cooling.

In order to achieve improved temperature control of the accumulator cells, heat sinks designed as cooling plates may conceivably be placed between the accumulators, such that these cooling plates are thermally connected to a cooling fluid at the front end. This leads to improved cooling of the accumulator cells, however, sufficient or uniform temperature control over the surface of the accumulator cells is still not provided. In addition, this variant leads to the above-described geometric changes in the accumulator cells during operation, in particular swelling, being insufficiently taken into account or not at all.

### SUMMARY

The present invention therefore addresses the problem of specifying improved or at least alternative embodiments for a heat sink for the accumulator cells of an accumulator, including such an accumulator, which embodiments are characterized, in particular, by more efficient temperature control, while at the same time increasing the service life of the accumulator.

The problem is solved according to the invention by the subject-matter of the independent claims. Advantageous embodiments are the subject-matter of the dependent claims, the description, and the drawings.

The present invention is based on the general idea of providing a heat sink for accumulator cells of an accumulator having two opposing walls, which delimit an inner volume, wherein the walls are movable relative to one another in the direction of spacing, and at least one of the walls is resting flat against an outer surface of an associated accumulator cell, wherein a cooling fluid flows through the inner volume during operation. The cooling-fluid flow through the heat sink and the flat contact on the accumulator cell result in fluidic separation of the accumulator cell from the cooling fluid and, at the same time, uniform and efficient temperature control of the accumulator cell. Moreover, the movable design of the walls allows for limited and reversible geometric modification of the associated accumulator cell, in particular, limited and reversible swelling of the accumulator cell. Thus, even with such thermally induced changes in the accumulator cell, reliable temperature control of the accumulator cell is still possible and consequently, damage to the accumulator cell is also prevented. Thus, with efficient control of the temperature of the accumulator cell, the service life of the accumulator cell and hence the associated accumulator is increased.

According to the inventive idea, the heat sink has a closed outer shell, which delimits the inner volume of the heat sink. The outer shell has two walls, i.e., a first and a second wall, which are arranged opposite one another in a spacing direction. The outer shell is designed, such that the walls are movable relative to one another in the direction of spacing, making this movability reversible. This means that the walls can move toward and away from one another in the direction of spacing. Furthermore, the heat sink comprises two connections, each of which being fluidically connected to the inner volume, such that a flow path of the cooling fluid passes through the inner volume via these connections. The connections are arranged at the periphery of the outer shell on the outer shell.

The arrangement of the connections at the periphery is such that when used in the associated accumulator, the connections are spaced apart from the accumulator cells associated with the heat sink.

The respective connection can be at least partially shaped on the outer shell.

The design of the walls, which are movable relative to one another, allows, in particular, for deformation of the heating sink, which deformation is reversible. Thus, the heat sink allows for limited swelling of the associated at least one accumulator cell.

The outer shell of the heat sink is advantageously fluid-tight toward the outside. In particular, this means that fluid flow through the heat sink through the inner volume can only occur via the connections of the heat sink.

One of the heat sink connections is preferably an inlet for admitting the cooling fluid into the inner volume, and the other connection is an outlet for discharging the cooling fluid. The inlet and the outlet are advantageously arranged and/or connected to the inner volume, such that the cooling fluid flows completely through the inner volume during operation.

The arrangement of the connections at the periphery of the outer shell means, in particular, that the connections are arranged in a direction extending transversely to the direction of spacing, in particular, in a direction of height extending transversely to the direction of spacing and/or in a direction of width extending transversely to the direction of spacing and the direction of height in an end face area of the outer shell, in particular, on a corresponding end face.

In principle, the outer shell can be made of any material.

Preferably, the outer shell is made of plastic. In other words, the outer shell is a plastic component. Advantageously, this will be an electrically insulating plastic. Thus, electrical and/or electromagnetic interactions between the accumulator cells and the heat sink and/or the cooling fluid are prevented, or at least reduced.

The heat sink has a thickness in the direction of spacing, a height in the direction of height, and a width in the direction of width. Thus, the relatively movable design of the walls in the direction of spacing means that the thickness of the heat sink to a limited extent is variable. A reduction in the thickness of the heat sink and thus a spacing of the walls in the direction of spacing is achieved by mechanical action of at least one of the walls in the direction of the other wall, as takes place with the swelling of the associated accumulator cell. Accordingly, as described above, the heat sink allows for limited swelling of the accumulator cell.

The heat sink is advantageously arranged in the associated accumulator in the direction of spacing between two associated accumulator cells, wherein the respective accumulator cell has an outer housing, the outer side of which rests flat against an outer surface facing away from the inner volume of an associated wall of the heat sink.

In the present case, tempering and temperature control refer to both heat transfer from the at least one accumulator cell to the heat sink, i.e., cooling of the accumulator cell, and heat transfer from the heat sink to the at least one accumulator cell, i.e., heating of the accumulator cell. In particular, the heat sink is used to cool the at least one associated accumulator cell.

In preferred embodiments, the movable design of at least one of the walls is realized by reversible deformability of the wall. This means that the wall, starting from an original shape, can be deformed and returned to its original shape. In particular, the wall is elastically deformable. The result is a simple and stable heat sink structure.

It is conceivable to design the outer heat sink shell as a deformable bag. This leads to simple, cost-effective and weight-reduced production of the heat sink. At the same time, the heat transfer between the outer shell and the at least one accumulator cell is improved. With simple and inexpensive production, the result is efficient cooling of the at least one associated accumulator cell and thus the accumulator.

It is also conceivable that the outer shell is made of foil. The outer shell is then a foil body. This makes possible simple production of the heat sink, while at the same time requires little installation space and reduces the weight.

The bag can be made of any material.

Preferably, the bag is made of foil. In other words, the bag is a foil body.

Alternatively, the outer shell may be produced like a shell structure from shells produced by injection molding. Thus, the outer shell may have a first half-shell and a second half-shell forming the outer shell, wherein the respective half-shell is an injection-molded component. This leads to a stable design of the heat sink. In addition, in this way, it is possible to simplify the elastic design of the walls of the heat sink.

The half-shells of the outer shell are advantageously joined together by material bonding, preferably by welding. This leads to a stable and fluid-tight connection of the half-shells to one another and thus to reliable fluid-tight limitation of the inner volume.

Preferred embodiments are those in which the first half-shell comprises the first wall, whereas the second half-shell comprises the second wall. This allows the walls to be flat and planar, especially the outer surfaces of the walls facing away from the inner volume. This results in improved two-dimensional contact of the outer surfaces with the respective associated outer surface of the associated accumulator cell.

Preferably, the connections are each formed on a half-shell. This means that either the respective half-shell comprises one of the connections, or one of the half-shells comprises both connections. This leads to a reduction in the number of individual components of the heat sink and consequently simpler production.

In preferred embodiments, an assembly for limiting a minimum distance between the walls, also referred to as a spacer assembly below, is provided in the inner volume of the heat sink. Thus, in particular, the spacer assembly results in preventing interruption of the flow path within the inner volume, even if the walls of the heat sinks move toward one another in the direction of spacing. The spacer assembly, therefore, delimits a minimum extension of the inner volume in the direction of spacing. In other words, the spacer assembly ensures that the inner volume does not decrease in the direction of spacing or that it defines a minimum thickness of the heat sink. At the same time, the spacer assembly limits the swelling of the at least one associated accumulator cell.

In principle, the spacer assembly may be of any design.

In an advantageous variant, used in particular when the outer shell is designed as a bag and/or a foil body, the spacer assembly in the inner volume comprises two cover plates opposite one another in the direction of spacing. A first of the cover plates rests flat against an inner surface of the first wall facing the inner volume, and a second of the cover plates rests flat against an inner surface of the second wall facing the inner volume. The respective cover plate has a shoulder protruding outwardly transversely to the direction of spacing, in particular, in the direction of the height, in each case in the direction of spacing toward the other cover plate.

Advantageously, the respective cover plate has such a shoulder on the outside perpendicular to the direction of spacing. In particular, this means that the respective cover plate has two such shoulders, which are spaced apart in the direction of the height, and are arranged on the outside of the associated cover plate. In particular, the cover plates may be identical components. The cover plates, in particular, the shoulders of the cover plates, are spaced apart in a first state of the heat sink. In a second state of the heat sink, the shoulders of the cover plates rest on one another, thus limiting the minimum distance. This means that in the second state, the at least one shoulder of the first cover plate rests on the at least one shoulder of the second cover plate. The shoulders therefore realize a stop of the cover plates thereby defining the minimum distance or the minimum thickness. When at least one of the walls is mechanically loaded in the direction of the other wall, the heat sink is therefore displaced from the first state to the second state. Thus, limited swelling of the associated, at least one accumulator cell is allowed, whereby at the same time, the cover plates, due to their elastic property, create a constant flat contact of the respective wall with the associated accumulator cell, even if the swelling of the accumulator cell decreases.

Preferably, the respective shoulder is arranged, such that it protrudes outward in the direction of the height and extend in the direction of the width. An associated shoulder of the other cover plate is preferably provided for the respective shoulder of the respective cover plate.

The cover plates are preferably detached from the associated wall, i.e., not fastened thereon. The cover plates therefore rest flat against the inner surface of the associated wall. In particular, this prevents or at least reduces tensions between the respective cover plate and the associated wall. In this way, damage to the outer shell and/or the cover plates is prevented.

The respective cover plate preferably has a smooth surface. The edges of the cover plates, too, are preferably smooth and/or rounded. This also prevents or at least reduces damage to the outer shell, in particular the bag or foil body.

The cover plates preferably extend to the periphery of the associated wall. In this way, the associated wall is stabilized over the corresponding height of the cover plate. Further, the cover plate thus keeps the outer shell and therefore the heat sink stable over the aforementioned height. The respective cover sheet preferably extends in the direction of the width to the periphery of the associated wall. Thus, the wall is also stabilized accordingly and held in the direction of the width. The aforementioned extensions of the cover plates, furthermore, create a stable extensive contact of the outer surfaces of the walls at the associated outer surface of the associated accumulator, and hence result in improved temperature control of the accumulator and/or improved compensation of accumulator swellings.

Alternatively or in addition, it is conceivable that the spacer assembly has at least two ribs protruding in the direction of spacing and spaced apart transversely to the direction of spacing. The ribs can limit the minimum distance by means of a stop located on the inner surface of the opposite wall in the direction of spacing. Alternatively or in addition, it is conceivable to arrange two opposite ribs of this type, which abut against one another, in order to limit the minimum distance.

Preferably, the respective rib extends in the direction of the height. Preferably, at least two of the ribs are spaced apart in the direction of the width. The course of the ribs in the direction of the height means that the minimum distance is limited over the corresponding height. The spacing of the ribs in the direction of the width leads, in particular, to an improved flow of the cooling fluid through the inner volume.

Embodiments in which a structure is arranged in the inner volume, which separates two branches of the flow path in the inner volume, are advantageous. Thus, the structure, also referred to below as the flow guide structure, entails that the flow path within the inner volume is split into at least two branches. This results in a more homogeneous cooling fluid flow through the heat sink and thus a more homogeneous heat transfer between the heat sink and the at least one accumulator cell. The result is a more efficient temperature control of the at least one accumulator cell.

The flow guide structure may, in particular, have at least two ribs, which advantageously correspond to the ribs of the spacer assembly. This means that in this variant, the spacer assembly may also constitute the flow guide structure.

In preferred embodiments, at least one of the connections of the heat sink has a shape allowing it to form a connection with an identical connection of another heat sink, in particular, an identical heat sink. Preferably, the connection is particularly designed, such that it can form a plug-in connection with an identical connection. Thus, in an associated accumulator, a simple and efficient and cost-effective connection of the cooling fluid to the heat sink may be realized by connecting the terminals accordingly

It is understood that, in addition to the heat sink, an accumulator having such a heat sink is also within the scope of the present invention.

Here, the accumulator has at least two accumulator cells, and at least one such heat sink. The heat sink and accumulator cells are advantageously alternately arranged in the direction of spacing. The respective accumulator cell has a first outer side and a second outer side opposite the first outer side in the direction of spacing. At least one of the at least one heat sink is arranged in the direction of spacing between two accumulator cells, such that the outer surface of the respective wall of the heat sink rests flat against one of the outer sides of the adjacent accumulators.

The respective accumulator cell can in principle be of any design.

In particular, the respective accumulator cell is a pouch cell.

Embodiments in which at least one of the accumulator cells is a prismatic cell are also conceivable.

The accumulator advantageously has two or more heat sinks, and two or more accumulator cells, wherein the heat sinks and accumulator cells are arranged alternately in the direction of spacing.

Preferably, at least two of the heat sinks, advantageously the respective heat sink, have a connection forming a plug-in connection with a heat sink connection, which is adjacent in the direction of spacing. This leads to a simple way of producing the accumulator and a simple and reliable supply of the cooling fluid to the heat sink.

At least two of the connections forming the plug-in connection, preferably the respective connections forming the plug-in connection, are preferably fastened to one another in a fluid-tight manner toward the outside by material bonding, particularly preferably by welding. This leads to a stable and reliable connection and supply, wherein leakages are prevented or at least reduced.

Further important features and advantages of the invention will be apparent from the subclaims, from the drawings, and from the accompanying description of the figures based on the drawings.

It is understood that the features mentioned above and those to be explained below may be used not only in the combination indicated in each case, but also in other combinations or separately, without deviating from the scope of the present invention.

### BRIEF DESCRIPTION OF THE DRAWINGS

Preferred exemplary embodiments of the invention are shown in the drawings and will be explained in more detail in the description below, where identical reference numerals denote identical or similar or functionally identical components

In the schematic drawings:

FIG. 1 is an isometric, exploded view of a heat sink of an accumulator,

FIG. 2 is a section through the heat sink,

FIG. 3 is an isometric, exploded view of the heat sink in another embodiment,

FIG. 4 is an isometric internal view of an accumulator with the heat sink of FIG. 3,

FIG. 5 is the view from FIG. 4 in another embodiment,

FIG. 6 is a section through the accumulator in a further embodiment,

FIG. 7 is a section through a heat sink in another embodiment,

FIG. 8 is a highly simplified, schematic representation of a motor vehicle having the accumulator.

### DETAILED DESCRIPTION

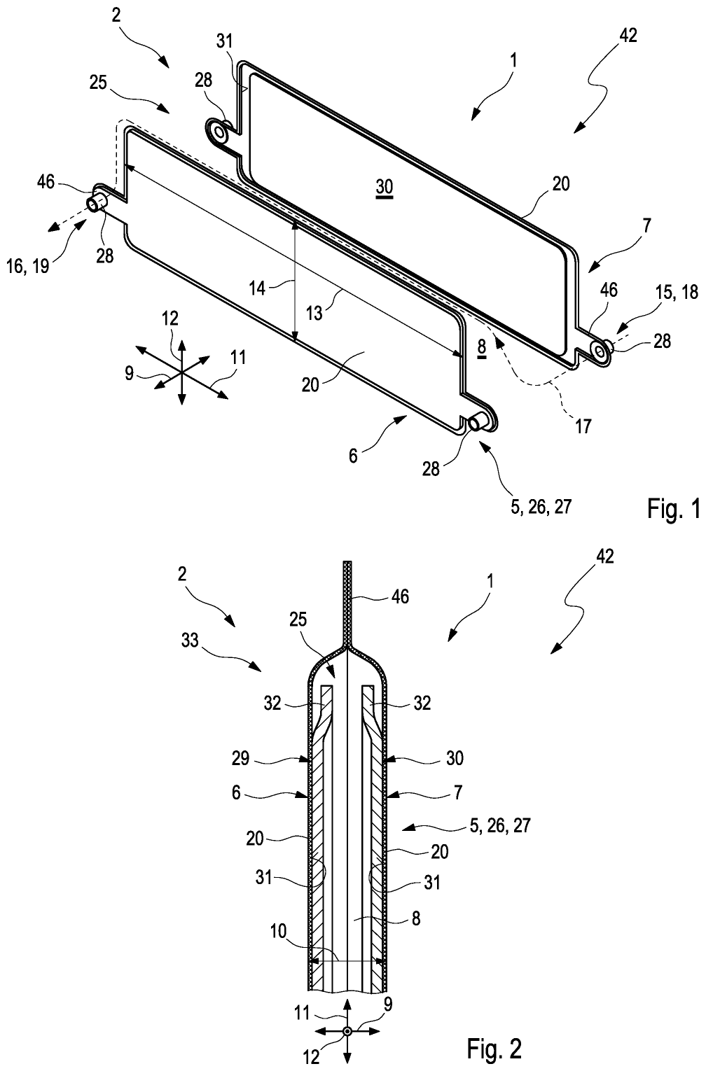

A heat sink 1, as shown, for example, in FIGS. 1-7, is used in an accumulator 2, as shown, e.g., in FIGS. 4-7. In the accumulator 2, the heat sink 1 is used for temperature control, in particular for cooling of accumulator cells 3, which may be designed as pouch cells 4 (see FIGS. 4-7). The heat sink 1 has a closed outer shell 5, with a first wall 6 and a second wall 7. The outer shell 5 is advantageously made of a plastic. The outer shell 5 is closed and delimits an inner volume 8 of the heat sink 1. Here, the first wall 6 and the second wall 7 are arranged opposite one another in a direction of spacing 9 of the heat sink 1. The heat sink 1 thus has a thickness 10 in the direction of spacing 9. The heat sink 1, furthermore, extends in a direction of height 11 extending transversely to the direction of spacing 9 and a direction of width 12 extending transversely to the direction of spacing 9 and transversely to the direction of height 11. The depicted heat sinks 1 are flat, i.e., they have a height 13 extending in the direction of height 11 and a width 14 extending in the direction of width 12, each of which is at least five times the thickness 10. In the exemplary embodiments shown, the heat sink 1 also has a height 13 that is greater than the width 14. In particular, the height 13 is at least twice the width 14. The outer shell 5 is designed, such that the walls 6, 7 are movable relative to one another in the direction of spacing 9. Moreover, the heat sink has two connections 15, 16, each of which is each fluidically connected to the inner volume 8, such that a flow path 17 of the cooling fluid passes through the inner volume 8 via the connections 15, 16. Here, one of the connections 15 serves as an inlet 18 for admitting the cooling fluid into the inner volume 8 and the other connection 16 serves as an outlet 19 for discharging the cooling fluid from the inner volume 8. Here, the respective connection 15, 16 is arranged on the outer shell 5 at a periphery thereof

The respective wall 6, 7 has an outer surface 20 facing away from the inner volume 8, and which in the exemplary embodiments shown is flat and planar.

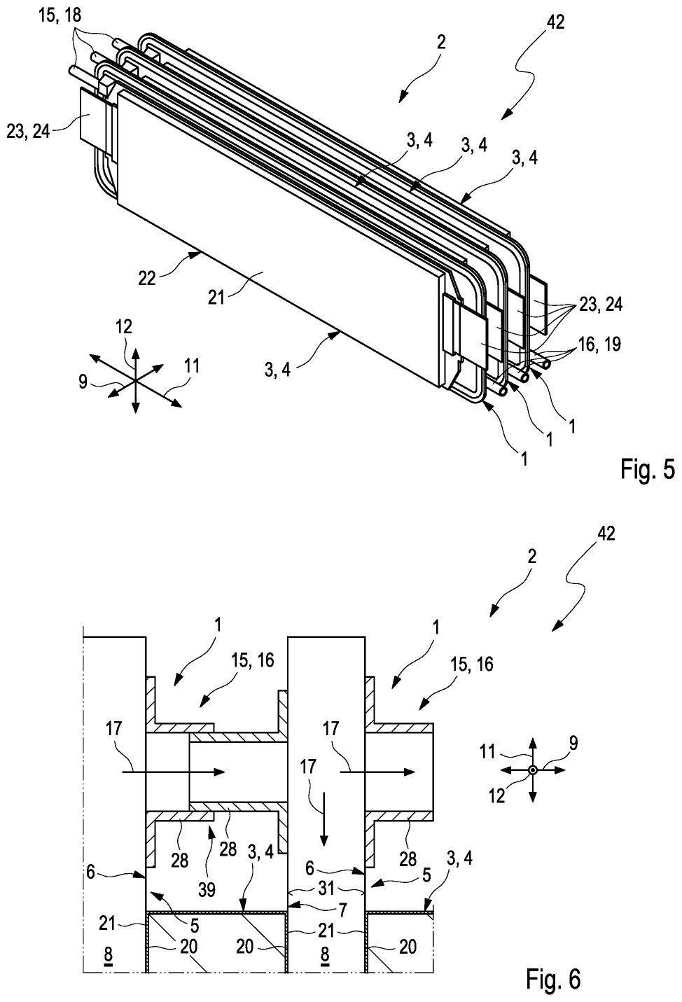

In the associated accumulator 2, the heat sink 1 is arranged between two accumulator cells 3 (see FIGS. 4 and 5). The respective accumulator cell 3 has two outer sides 21 opposite one another in the direction of spacing 9, wherein the outer sides 21 are flat and planar in the exemplary embodiments shown. The outer sides 21 are part of an outer shell 22 of the accumulator cell 3, wherein this outer shell 22 is referred to below as the cell housing 22 to allow for better differentiation. Within the cell housing 22, the composition of the respective accumulator cell 3 is non-visible and electrochemically active. The respective accumulator cell 3 also has two electrodes 23, which in the exemplary embodiments shown are designed as so-called cell outgoing conductors 24. The electrodes 23 protrude from the cell housing 22 in the direction of the height 11 in the exemplary embodiments shown. The heat sink 1 rests flat against the outer surface 20 of one of the walls 6, 7 on one of the outer sides 21 of one of the accumulator cells 3. The outer surface 20 of the other wall 6, 7 rests flat against an outer side 21 of the other accumulator cell 3. As can be seen in particular from FIGS. 4 and 5, it is preferred if the outer sides 21 associated with the walls 6, 7 are shorter in the direction of height 11 than the associated wall 6, 7. Moreover, it is preferred if the outer sides 21 in the direction of width 12 are slightly smaller than the associated wall 6, 7.

The flat contact of the outer surfaces 20 of the walls 6, 7 on the respective associated outer side 21 of the respective associated accumulator cell 3 results in improved, homogeneous heat transfer between the respective accumulator cell 3 and the heat sink 1, and thus the cooling fluid flowing through the heat sink 1. The temperature control of the accumulator cells 3, in particular cooling of the accumulator cells 3, is thus improved. The design of the walls 6, 7, which is movable relative to one another in the direction of spacing 9, furthermore, allows for limited expansion of the accumulators 3 in the direction of spacing 9, i.e., limited swelling of the accumulators 3, while the accumulators 3 continue to rest flat on the heat sink 1. The heat sink 1 therefore has a variable thickness 10. In particular, the distance between the walls 6, 7 in the direction of spacing 9 and thus the thickness 10 decreases, when the walls 6, 7 are exposed to mechanical impact, as occurs with swelling of the accumulator cells 3. In this case, the mobility is reversible, such that the walls 6, 7 return to their original relative position, when the mechanical impact is reduced, i.e., the thickness 10 is increased. A maximum extension of the thickness 10 is determined by the design of the outer shell 5.

A minimum spacing of the walls 6, 7 in the direction of spacing 9, i.e., the limitation of a minimum extension of the inner volume 8 in the direction of spacing 9, is realized by a spacer assembly 25 of the heat sink 1, which is arranged in the inner volume 8. The swelling of the accumulator cells 3 is thus being limited. In addition, interruption of the flow of the cooling fluid through the inner volume 8 is prevented by the mechanical impact of the walls 6, 7, i.e., for example, when the accumulator cells 3 swell. Consequently, the spacer assembly 25 prevents the flow path 17 from being interrupted within the inner volume 8.

FIGS. 1 and 2 show a first embodiment of the heat sink 1, wherein FIG. 1 is an isometric view of the heat sink 1, which is shown in two halves. FIG. 2 shows a section through the heat sink 1 in the direction of spacing 9. In this exemplary embodiment, the outer shell 5 is designed as a bag 26, which in particular is made of foil. The outer shell 5, in particular, the bag 26, is therefore a foil body 27. As can be seen, in particular from FIG. 1, in this exemplary embodiment, the connections 15, 16 are arranged at opposite ends of the outer shell 5 in the direction of height 11. The connections 15, 16 are realized on extensions 46 protruding in the direction of height 11. The respective connection 15, 16 has at least one connecting piece 28. The heat sink 1 is designed to be single-symmetrical overall with respect to rotations about the direction of spacing 9. This means that 180° rotations of the heat sink 1 about the direction of spacing 9 result in the same design, such that the relevant arrangement of the heat sink 1 in the associated accumulator 2 may be simplified. In this exemplary embodiment, the spacer assembly 25 has a first cover plate 29 associated with the first wall 6, and a second cover plate 30 associated with the second wall 7. The respective cover plate 29, 30 is smooth and rests flat against an inner surface 31 of the associated wall 6, 7 facing the inner volume 8. The respective cover plate 29, 30 has two shoulders 32 which are situated opposite in the direction of height 11 and arranged on the outside, with the respective shoulder 32 protruding in the direction of the opposite cover plate 29, 30. The shoulders 32 are only shown in FIG. 2, where only one shoulder 32 of the respective cover plate 29, 30 is visible in FIG. 2 due to the representation. Thus, for the respective shoulder 32 of the respective cover plate 29, 30, a shoulder 32 of the other cover plate 29, 30, which is associated and opposite in the direction of spacing 9, is provided. In a first state 33 of the heat sink 1 shown in FIG. 2, the shoulders 32 are spaced apart. If the walls 6, 7 are mechanically impacted in the direction of spacing 9, i.e., the accumulator cells 3 are swelling, then the walls 6, 7 move in the direction of spacing 9, i.e., the thickness 10 is reduced. The heat sink 1 is thus moved toward a second state, not shown, in which the associated shoulders 32 abut against each other, thus preventing further relative movement of the walls 6, 7 with respect to one another and thus a further reduction of the thickness 10. Said swelling of the accumulator cells 3 is thus limited and still allows a flow of the cooling fluid through the inner volume 8. As can be seen, in particular from FIG. 1, the respective cover plate 29, 30 extends over a substantial area of the associated wall 6, 7. The elastic property of the cover plates 29, 30 further causes the walls 6, 7 to move toward the associated outer side 21, when the swelling decreases. Thus, the heat sink 1 moves back toward the first state 33, as the swelling decreases. Hence, the outer sides 21 continue to rest flat against the associated outer surface 20.

In the exemplary embodiment shown in FIGS. 1 and 2, the outer shell 5 designed as a bag 26 or foil body 27 may consist of the halves shown in FIG. 1, wherein these halves are joined to one another by material bonding, preferably by welding.

In the exemplary embodiment shown in FIGS. 1 and 2, the connecting pieces 28 of the connections 15, 16 protrude in the direction of spacing 9.

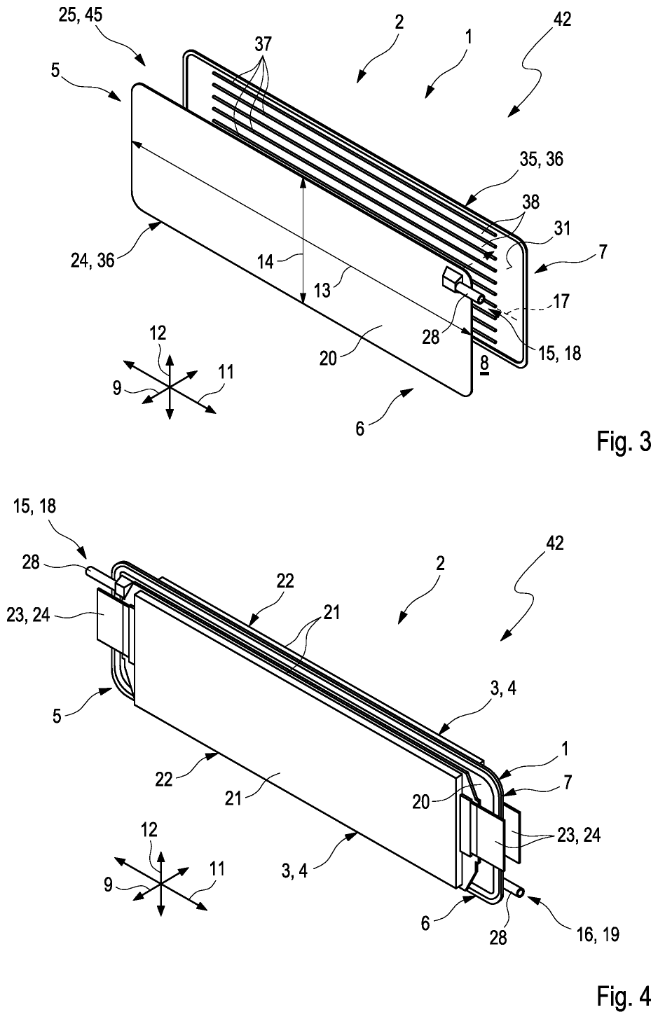

In the exemplary embodiment shown in FIGS. 3-5, the heat sink 1 has two half-shells 34, 35, which form the outer shell 5. The respective half-shell 34, 35 is produced by an injection molding process. The respective half-shell 34, 35 is therefore an injection-molded component 36. The half-shells 34, 35 are connected to one another by material bonding, preferably by welding. In the exemplary embodiment shown, the first half-shell 34 comprises the first wall 6, whereas the second half-shell 35 comprises the second wall 7. In this exemplary embodiment, the relatively movable design of the walls 6, 7 in the direction of spacing 9 is realized by the design of the half-shells 34, 35, in particular a wall thickness of the half-shells 34, 35. In this embodiment, the walls 6, 7 are elastic in the direction of spacing 9 and thus allow for limited swelling of the accumulator cells 3 and, at the same time, causing the walls 6, 7 to move apart, when the swelling decreases, thereby further providing a flat contact of the outer sides 21 on the outer surfaces 20.

In the exemplary embodiment of FIGS. 3 and 4, the spacer assembly 25 comprises ribs 37 protruding from the inner surface 31 of the respective wall 6, 7 in the direction of spacing 9, extending in the direction of height 11 and spaced apart in the direction of width 12. Preferably, for the respective rib 37 of the respective wall 6, 7, a rib 37 of the other wall 6, 7 oppositely situated in the direction of spacing 9, is provided. Thus, in the second state not shown, the ribs 37 may abut one another and thus define a lower limit of the thickness 10 or limit the minimum extension of the inner volume 8 in the direction of spacing 9. In this case, the ribs 37 are thus components of the spacer assembly 25. At the same time, the fins 37 guide the cooling fluid inside the inner volume 8. In particular, the ribs 37 cause branches 38 of the flow path 17 to be created or separated from one another in the inner volume 8. The ribs 37 are thus, at the same time, components of a flow guide structure 45, which creates or separates branches 38 of the flow path 17 in the inner volume 8. The spacer assembly 25 therefore corresponds to the flow guide structure 45.

In the exemplary embodiment shown in FIGS. 3-5, the respective half-shell 34, 35 comprises one of the connections 15, 16. The respective connection 15, 16 protrudes from the associated wall 6, 7 of the associated half-shell 34, 35 in the direction of spacing 9, wherein a connecting piece 28 of the connection 15, 16 protrudes in the direction of height 11.

In the exemplary embodiment of FIG. 4, the accumulator 2 is shown along with an internal view of the accumulator 1, such that a housing of the accumulator 2, in which the accumulator cells 3 and the heat sink 1 are accommodated, is invisible. Thus, the accumulator 2 may have a heat sink 1 and two accumulator cells 3.

As can be seen from FIG. 5, it is preferred that the accumulator 2 has at least two accumulator cells 3 and at least two heat sinks 1, wherein the heat sinks 1 and the accumulator cells 3 are arranged alternately in the direction of spacing 9.

FIG. 6 shows another embodiment of the accumulator 2 or heat sinks 1. A section through the accumulator 2 in the area of associated connections 15, 16, e.g., in the area of inlets 18, for two successive heat sinks 1 in the direction of spacing 9 are visible here. As can be seen from FIG. 6, these connections 15, 16 are identical and designed, such that they can be plugged into one another. In other words, the connections 15, 16 form a plug-in connection 39. Thus, by plugging the connections 15, 16 into one another, in the present case, the nozzles 28 of the connections 15, 16, it is possible to supply the cooling elements 1 of the accumulator 2 with the cooling fluid in a simple and reliable manner. The connections 15, 16, which together form a plug-in connection 39, are advantageously connected to one another by material bonding, preferably by welding.

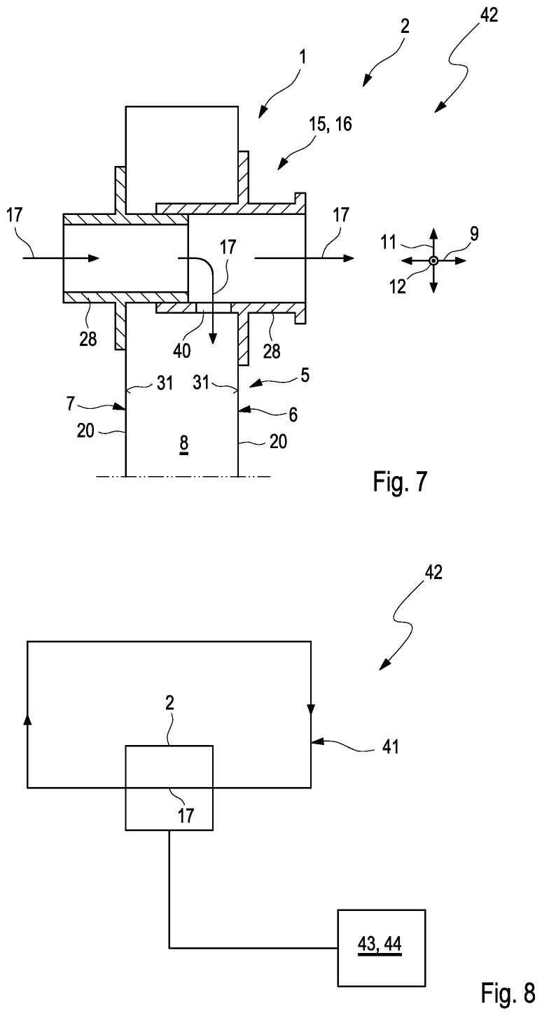

FIG. 7 shows another embodiment of the heat sink 1 in the area of one of the connections 15, 16. As can be seen from FIG. 7, the connection 15, 16 within the heat sink 1 has an aperture 40, which allows a restricted and controlled flow of cooling fluid into and out of the inner volume 8.

According to FIG. 8, the accumulator 2 is included in a cooling circuit 41, through which the cooling fluid circulates, such that the cooling fluid flows along the flow path 17 through the accumulator 2 and the at least one heat sink 1. According to FIG. 8, the accumulator 2 and the cooling circuit 41 may be components of a motor vehicle 42, in which the accumulator 2 can be used for the electrical supply of a drive 43, e.g., an electric motor 44, of the motor vehicle 42.

1. A heat sink for accumulator cells, of an accumulator, comprising:
a closed outer shell which delimits an inner volume of the heat sink, the outer shell includes a first wall and a second wall opposite the first wall in a direction of spacing, and the first and second walls are movable relative to one another in the direction of spacing; and
two connections arranged at a periphery of the outer shell the connections are fluidically connected to the inner volume such that a flow path of a cooling fluid extends through the inner volume via the connections.

2. The heat sink according to claim 1,
wherein at least one of the first and second walls is reversibly deformable in the direction of spacing.

3. The heat sink according to claim 1,
wherein the outer shell is designed as a deformable bag.

4. The heat sink according to claim 3,
wherein the outer shell is designed as a foil body.

5. The heat sink according to claim 1,
wherein the outer shell includes a first half-shell and a second half-shell, each of which being an injection-molded component.

6. The heat sink according to claim 1,
wherein a spacer assembly is arranged in the inner volume, the spacer assembly is configured to delimit a minimum extension of the inner volume in the direction of spacing such that an interruption of the flow path within the inner volume is prevented by a relative mobility of the walls.

7. The heat sink according to claim 6, wherein:
the spacer assembly has a first cover plate which rests flat against an inner surface which faces the inner volume of the first wall, and a second cover plate which rests flat against an inner surface facing the inner volume of the second wall;
one of the first and second cover plates is situated on the outside transversely to the direction of spacing and has at least one shoulder protruding in the direction of spacing toward the other one of the first and second cover plates;
in a first state of the heat sink, the first and second cover plates are spaced apart; and
in a second state of the heat sink, at least one of the shoulders of the first cover plate rests on at least one of the at least one shoulders of the second cover plate such as to limit a minimum distance.

8. The heat sink according to claim 6,
wherein the spacer assembly includes at least two ribs protruding in the direction of spacing and are spaced apart transversely to the direction of spacing.

9. The heat sink according to claim 1, wherein:
at least one of the connections has at least one connecting piece protruding in the direction of spacing; and
the at least one of the connections is shaped, to form a plug-in connection with an identical connection.

10. The heat sink according to claim 1,
wherein a flow guide structure is arranged in the inner volume, the flow guide structure separates two branches of the flow path within the inner volume from each other.

11. An accumulator, comprising:
at least two accumulator cells; and
at least one heat sink according to claim 1;
wherein the respective accumulator cell has two opposite outer sides in the direction of spacing, and wherein at least one of the at least one heat sink is arranged between two of the at least two accumulator cells such that the respective wall of the heat sink rests flat against one of the outer sides of one of the accumulators.

12. The accumulator according to claim 11, wherein:
the accumulator includes at least two heat sinks;
an accumulator cell is arranged in the direction of spacing between the heat sinks; and
at least one of the connections of one heat sink forms a plug-in connection with an associated connection of the other heat sink.

13. The accumulator according to claim 12,
wherein at least two of the connections forming the plug-in connection are fastened to one another by material bonding and in an outwardly fluid-tight manner.

14. The accumulator according to claim 11, wherein at least one of the first and second walls of the at least one heat sink is reversibly deformable.

15. The accumulator according to claim 11, wherein the outer shell of the at least one heat sink is designed as a deformable bag.

16. The accumulator according to claim 11, wherein the outer shell of the at least one heat sink is designed as a foil body.

17. The accumulator according to claim 11, wherein the outer shell of the at least one heat sink includes a first half-shell and a second half-shell.

18. The accumulator according to claim 18, wherein the first half-shell and the second half-shell are injection-molded components.

19. The accumulator according to claim 11, wherein the at least one heat sink includes a spacer assembly.

20. The accumulator according to claim 19, wherein the spacer assembly includes a first cover plate and a second cover plate.
